(19) United States
(12) Patent Application Publication
(10) Pub. No.: US 2008/0121474 A1
(43) Pub. Date: May 29, 2008

(54) Friction Materials Comprising Coal Combustion And Coal Gasification Byproducts

(75) Inventor: Yoginder Paul Chugh, Murphysboro, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Board of Trustees of Southern Illinois University

(21) Appl. No.: 11/927,206

(22) Filed: Oct. 29, 2007

Related U.S. Application Data
(60) Provisional application No. 60/854,953, filed on Oct. 28, 2006.

(51) Int. Cl. F16D 65/04; B27N 3/08; B23P 15/18

(52) U.S. Cl. 188/251 A; 264/239; 29/233

(57) ABSTRACT

The invention relates generally to compositions of materials used in friction applications, and more specifically to compositions that are fabricated from the byproducts of coal combustion and/or coal gasification and can be used to provide friction components for braking and power transfer applications.

### CROSS-REFERENCE TO RELATED APPLICATION

The benefit under 35 U.S.C. §119(e) of U.S. provisional patent application Ser. No. 60/854,953, filed Oct. 28, 2006, the entire disclosure of which is incorporated herein by reference, is hereby claimed.

### FIELD OF INVENTION

The invention relates generally to compositions of materials used in friction applications, and more specifically to compositions that are fabricated from the byproducts of coal combustion and/or coal gasification and can be used to provide friction components for braking and power transfer applications.

### BACKGROUND

Friction materials for brakes should possess several friction performance properties. First, they should demonstrate a relatively constant coefficient of friction (“COF”) over a wide temperature range in use while observing only a small reduction in friction (fade) at higher operating temperatures. Second, the materials should dissipate friction-generated heat efficiently during the braking process. Third, the materials should have a low wear rate in use. In addition, they should have other requisite properties such as strength, low noise and vibration, and absence of powder during the wear process. Resin-bonded friction materials are most common and are categorized into organic (asbestos-based), semi-metallic, and non-asbestos organic. Most of the discussion below refers to semi-metallic friction materials.

Conventional semi-metallic friction materials for brakes typically contain 20-30 ingredients that are processed dry and hot pressed using a binder. These ingredients may be subdivided into four (4) classes, described as follows:

Friction Modifiers—These include materials that develop and modify friction properties. Examples include aluminum oxide, chromium oxide, silicon oxide, wollastonite (calcium silicate), rock wool, mica (aluminum silicate), vermiculite (hydrated calcium-aluminum silicate), magnesium oxide (MgO), zinc oxide, zirconium silicate, etc. Brass, copper, aluminum, and zinc chips or powder improve fade performance. Graphite, metallurgical coke, and molybdenum disulfide, talc, rubber etc. act as solid lubricants to control friction coefficient.

Reinforcement Fibers—These assume tensile, shear and bending stresses within the material and hold it together to reduce wear. Examples include aramid pulp, aramid fibers, metallic fibers (steel, aluminum, copper), glass fibers, ceramic fibers, basalt fiber, slag fibers, and pulverized mineral fiber (PMF).

Fillers—As the name implies these low cost materials extend the friction modifier and reinforcement fiber matrix by filling voids. Typical examples include: baryte (barium sulfate), limestone (calcium carbonate), and clay.

Binders—Phenolic resin is most commonly used to bind all ingredients together because of its performance at high temperatures and its ability to provide oxidation resistance.

Commercial production of brake pads for disc brakes currently includes dry blending of all ingredients and then molding the mixture under applied heat and pressure. Brake pad ingredients typically include as many as 20 to 30 materials, as previously suggested, and each material has varying size, shape, and specific gravity. Therefore, dry blending of these materials does not produce a uniform mixture and segregation occurs during the fabrication process, leading to larger variability in performance for any fixed proportion of materials mixed.

A magnified image of a current semi-metallic friction material produced with a microscope, as shown in FIG. 1, for example, confirms that the ingredients in such materials typically are not uniformly distributed, but rather are segregated, and therefore the materials demonstrate variability in thermal and friction properties. For example, metallic fibers have very different thermal properties than fillers. Similarly, metallic fibers and fillers have very different stiffness and friction properties. High heterogeneity in ingredients therefore results in non-uniform thermal stresses and non-uniform load and stress distributions within the friction material during its performance. These differences negatively affect the friction, heat and wear characteristics of current semi-metallic friction materials.

Semi-metallic friction materials are typically bonded to a metallic backing plate to form a brake pad. In use, the friction material generates a great deal of heat. In poorly designed friction materials, this heat may be transmitted through the friction material and the backing plate may heat up the system behind the plate that applies the braking force. This can lead to situations such as the undesirable boiling of brake fluid in the braking system. Such heat characteristics of friction materials can be a disadvantage that even may lead to safety problems.

Wear is also an important issue for brakes using semi-metallic friction materials, since wear affects the lifetime cost and performance of the material. Current materials, because of their heterogeneous composition, exhibit wear characteristics which are less than optimal. For example, softer components such as fillers and binders can wear faster than the hard metals in the material. This appears to lead to a situation where the metal may remain exposed at the friction surface, and provide the majority of the frictional force, but with limited contact area because of the disproportionate wear of other components in the formed material. Because the surrounding material has worn away, the metal is more apt to shear off or deform, leading to increased wear, as well as other undesirable performance characteristics such as noise and vibration. In some applications, metal at high temperatures effectively “smears” across areas of the friction surface, which presents a further disadvantage.

Byproducts of coal combustion have been incorporated in friction materials for automotive brake applications. Some researchers have used the word “fly ash” in their publications loosely irrespective of the type of coal and combustion process used. For example, most past efforts have not differentiated between fly ash from the combustion of bituminous coal (“F-fly ash”), fly ash from the combustion of sub-bituminous or lignite coal (“C-fly ash”), and fly ash that is a byproduct of fluidized bed combustion of coal (“FBC fly ash”). The physical and chemical characteristics of these materials are very different.

For example, U.S. Pat. Pub. No. 2003/0055126-A1 discloses a composition including a friction modifier for adjusting coefficient of friction and a strengthener for providing structural integrity, and also a fly ash filler for increasing the volume. In this invention, a binder, such as phenolic resin, holds the friction modifier, the strengthener, and the filler together. However, the particular type of fly ash is not disclosed. Though it is not clear how these coefficients of friction were determined, the coefficient of friction developed was relatively low (0.1 to about 0.38) for the disclosed compositions. Comparisons with Original Equipment by Manufacturer (OEM) equipment are not provided, however.

In 1996, Malhotra incorporated PCC fly ash from an Illinois coal burning power plant, FBC spent bed ash, and sulfate-rich scrubber sludge, coal char, coal tar, slag fibers and iron particles for bench-scale development of friction materials for automotive brakes. Six compositions were tested, though their exact ingredients and proportions were not reported. Malhotra reported, however, that PCC fly ash addition beyond 40 percent by volume (vol. %) significantly reduced the strength of the friction material.

In 2002, Malhotra, Valimbe, and Wright published a study on the effects of fly ash and bottom ash on the friction behavior of composites. Bench scale studies were conducted with a basic composition of 45 vol. % phenolic binder, 22 vol. % slag fibers, and 33 vol. % wet scrubber sludge from flue gas desulphurization technologies. Additional compositions involved adding either PCC fly ash or PCC bottom ash in the 8 to 30 vol. % range with consistent reduction in the amounts of the ingredients in the basic composition. Compositions either included F-fly ash or bottom ash, but not both. The best compositions contained 20 vol. % of fly ash or bottom ash, but their high binder content (40 vol. %) would make their commercial implementation impractical from an economic standpoint. Except for the basic composition, the wear rates for all tested compositions, were unacceptably high (21.5% to 44.5% based on thickness loss during Friction Assessment Screening Test (FAST) testing).

In 2003, Hee performed studies to assess if FBC fly ash and FBC spent-bed material (sometimes called bottom ash) from a power plant could be successfully incorporated into semi-metallic friction materials. Six compositions were studied with FBC fly ash and FBC spent-bed ash in the following amounts: (25, 0), (20, 5), (15, 10), (5, 20), and (0, 25), where the first number is percent weight fraction of FBC fly ash, and the second number is percent weight fraction of FBC spent-bed material. The weight percent of the other 14 ingredients was held constant for all compositions. They reported COF values from 0.34 to 0.41, where the COF typically increased along with the amount of FBC spent-bed ash material included. However, the wear rates for the compositions were high, ranging from 12.9% to 30.30%.

### SUMMARY

Compositions according to the invention provide friction materials possessing advantageous properties and in one embodiment generally comprise at least two friction modifier components advantageously obtained from coal combustion and coal gasification byproducts selected from the group consisting of pulverized coal combustion fly ash, pulverized coal combustion bottom ash, fluidized bed combustion fly ash, a vitreous fraction of coal gasification, a wet byproduct of flue gas desulphurization, and fluidized bed combustion dry bottom ash (“spent-bed material”), at least one binder component, and at least one fiber component.

In another embodiment, the compositions comprise at least one friction material ingredient selected from the group consisting of F-fly ash, C-Fly ash, and FBC fly ash, copper powder, aluminum powder, and steel powder, the friction material ingredient or combination of friction material ingredients comprising 5% to 55% weight of the composition; at least one different friction material ingredient selected from the group consisting of bottom ash and coal gasification byproduct, the different friction material ingredient or combination of ingredients comprising 0.1% to 35% weight of the composition; a reinforcement fiber selected from the group consisting of aramid fiber, copper fiber, steel fiber, glass fiber, and ceramic fiber in an amount from 2% to 12% by weight of the composition; a binder selected from the group consisting of phenolic resin and epoxy in an amount from 5% to 30% by weight of the composition; and a lubricating ingredient selected from group consisting of graphite, molybdenum sulfide, and potassium titanate, talc, rubber in an amount of 0.1% to 20% weight of the composition.

The invention further provides methods of making work pieces capable of being used in power transfer and braking applications comprising (friction materials) comprising combining at least two coal combustion and coal gasification byproducts selected from the group consisting of pulverized coal combustion fly ash, pulverized coal combustion bottom ash, FBC fly ash, a vitreous fraction of coal gasification, a wet byproduct of flue gas desulphurization, and fluidized bed combustion dry bottom ash, with at least one binder component, at least one fiber component, and optionally, at least one additional friction modifier component to form a mixture, and molding the mixture to form a work piece capable of being used in power transfer and braking applications. The method may further comprise attaching the work piece to a steel plate. Typically, molding is effected at elevated temperature and pressure. Thus, hot pressing may be used to form the friction work piece.

In another embodiment, the invention provides methods of making work pieces capable of being used in power transfer and braking applications comprising combining at least one friction material ingredient selected from the group consisting of F-fly ash, C-Fly ash, and FBC fly ash, copper powder, aluminum powder, and steel powder; at least one friction material ingredient selected from the group consisting of bottom ash and coal gasification byproduct; a reinforcement fiber selected from the group consisting of aramid fiber, copper fiber, steel fiber, glass fiber, and ceramic fiber; a binder selected from the group consisting of phenolic resin and epoxy; and a lubricating ingredient selected from group consisting of graphite, molybdenum sulfide, and potassium titanate, talc, and rubber.

Work pieces comprising a friction material in accordance with the above embodiments are also provided. Typically, the work piece further comprises a steel plate, and the friction material is attached to the steel plate.

### DESCRIPTION OF THE DRAWINGS

FIG. 1. is a photomicrograph of a representative commercially-available friction material for brakes.

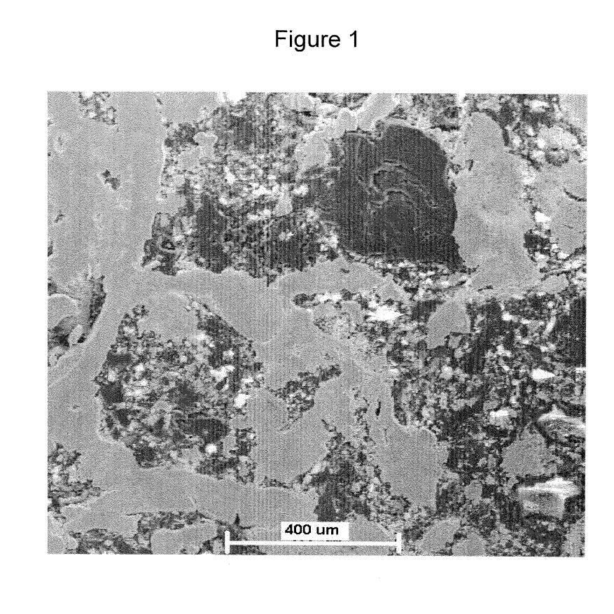

FIG. 2. is a chart showing the relative component proportions of several compositions in accordance with the invention.

FIG. 3. is a photomicrograph of one composition in accordance with the invention demonstrating a relatively homogeneous particle structure.

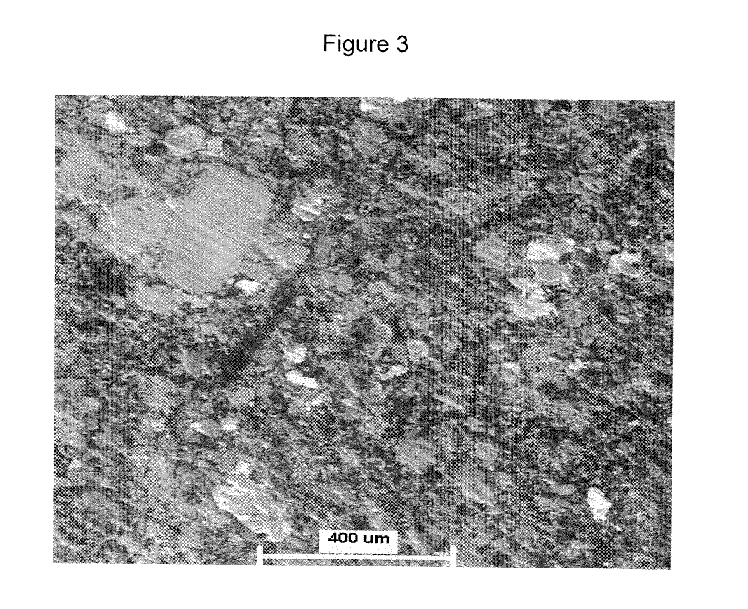

### DETAILED DESCRIPTION

Compositions according to the invention provide friction materials possessing advantageous properties and in one embodiment such friction materials generally comprise at least two friction modifier components advantageously obtained from coal combustion and coal gasification byproducts selected from the group consisting of pulverized coal combustion fly ash, pulverized coal combustion bottom ash, fluidized bed combustion fly ash, a vitreous fraction of coal gasification, a wet byproduct of flue gas desulphurization, and fluidized bed combustion dry bottom ash (“spent-bed material”), at least one binder component, and at least one fiber component. The pulverized coal combustion fly ash may be either F-fly ash or C-fly ash.

In another embodiment, the compositions comprise at least one friction material ingredient selected from the group consisting of F-fly ash, C-Fly ash, and FBC fly ash, copper powder, aluminum powder, and steel powder, the friction material ingredient or combination of friction material ingredients comprising 5% to 55% by weight of the composition; at least one different friction material ingredient selected from the group consisting of bottom ash and coal gasification byproduct, the different friction material ingredient or combination of ingredients comprising 0.1% to 35% by weight of the composition; a reinforcement fiber selected from the group consisting of aramid fiber, copper fiber, steel fiber, glass fiber, and ceramic fiber in an amount from 2% to 12% by weight of the composition; a binder selected from the group consisting of phenolic resin and epoxy in an amount from 5% to 30% by weight of the composition; and a lubricating ingredient selected from group consisting of graphite, molybdenum sulfide, and potassium titanate, talc, and rubber in an amount of 0.1% to 20% by weight of the composition.

The byproducts may be used in raw form, or processed mechanically or chemically to limit particle size to a fixed range for all ingredients, to establish a homogeneous mixture. The friction performance properties can be modified for different applications by altering the relative content of the ingredients and the particle size of the ingredients. The friction material can be used as a work piece in applications such as vehicle brake pads and power transmission clutch plates. The friction materials exhibit desirable friction performance properties including coefficient of friction, fade, wear rate, noise and vibration and operating temperature, and can be manufactured at a low cost because of the waste materials employed and the ability to utilize unmodified common manufacturing processes. The friction materials desirably demonstrate coefficient of frictions between 0.35 and 0.65.

The invention further provides methods of making friction materials comprising combining at least two coal combustion and coal gasification byproducts selected from the group consisting of pulverized coal combustion fly ash, pulverized coal combustion bottom ash, FBC fly ash, a vitreous fraction of coal gasification, a wet byproduct of flue gas desulphurization, and fluidized bed combustion dry bottom ash, with at least one binder component, at least one fiber component, and optionally, at least one additional friction modifier component to form a mixture, and molding the mixture to form a work piece capable of being used in power transfer and braking applications. In another embodiment, the invention provides methods of making friction materials comprising combining at least one friction material ingredient selected from the group consisting of F-fly ash, C-Fly ash, and FBC fly ash, copper powder, aluminum powder, and steel powder; at least one friction material ingredient selected from the group consisting of bottom ash and coal gasification byproduct; a reinforcement fiber selected from the group consisting of aramid fiber, copper fiber, steel fiber, glass fiber, and ceramic fiber; a binder selected from the group consisting of phenolic resin and epoxy; and a lubricating ingredient selected from group consisting of graphite, molybdenum sulfide, and potassium titanate, talc, and rubber. The methods may further comprise attaching the work piece to a steel plate. Typically, molding is effected at elevated temperature and pressure. Thus, hot pressing may be used to form the friction work piece.

Combustion byproducts are produced when coal is heated in an oxidizing environment to produce heat. Fly ash is airborne ash captured during coal combustion, and bottom ash is quenched ash obtained from the molten ash in coal combustion chambers (“bottom ash,” also known as “boiler slag”). Gasification involves the chemical conversion of coal into synthetic gaseous fuel. A solid, vitreous fraction byproduct is produced during coal gasification. The physical and chemical characteristics of the various gasification and combustion byproducts are different. These byproducts exist in large quantities as “unused waste” in most countries in the world where coal is used for power generation or for chemicals production. Their existence as “unused waste” products poses problems of disposal and storage, and represents an inefficient use of the raw material coal.

In various embodiments, the compositions according to the present invention may contain from about 5 to about 90 wt. %, from about 30 to about 75 wt. %, from about 35 to about 65 wt. %, and/or about 45 to about 60 wt. % of coal combustion and coal gasification byproduct(s) selected from the group consisting of pulverized coal combustion fly ash, pulverized coal combustion bottom ash, fluidized bed combustion fly ash, a vitreous fraction of coal gasification, a wet byproduct of flue gas desulphurization, and fluidized bed combustion dry bottom ash. Typically, the coal combustion and coal gasification byproducts are selected from pulverized coal combustion fly ash, pulverized coal combustion bottom ash, fluidized bed combustion fly ash, and a vitreous fraction of coal gasification. The pulverized coal combustion fly ash may be F-fly ash or C-fly ash.

The compositions also typically include at least one reinforcement fiber and at least one binder. The reinforcement fiber may be selected from the group consisting of aramid fibers, copper fibers, steel fibers, glass fibers, and ceramic fibers. Typically, the reinforcement fiber is present in an amount from about 2% to 12% by weight of the composition. The binder may be selected from the group consisting of phenolic resin and epoxy resins. Typically, the binder is present in an amount from 5% to 30% by weight of the composition.

The compositions of the invention advantageously utilize the aforementioned waste combustion byproducts to provide friction materials. Industrial waste byproducts from metal fiber production (e.g., waste copper powder) may also be included in the compositions, for example, at levels between about 5 wt. % and about 10 wt. %. More specifically, the friction materials disclosed herein may comprise greater than 70 wt. % of currently-wasted industrial byproducts.

The compositions may optionally comprise one or more additional friction modifier components. Suitable additional friction modifier components include but are not limited to (1) friction developers such as aluminum oxide, chromium oxide, silicon oxide, wollastonite (calcium silicate), rock wool, mica (aluminum silicate), vermiculite (hydrated calcium-aluminum silicate), magnesium oxide (MgO), zinc oxide, and zirconium silicate, steel fibers, potassium titanate, copper powder, aluminum powder, and steel powder, (2) fade improvers such as brass chips or powder, copper chips or powder, aluminum chips or powder, zinc chips or powder, and (3) solid lubricants such as graphite, metallurgical coke, molybdenum disulfide, talc, and rubber.

The various coal combustion and coal gasification ingredients typically have a relatively homogeneous particle size. The particle size of the coal combustion and coal gasification ingredients typically falls within about 1 micron and 250 microns, but may also be between 5 microns and about 125 microns, 5 microns and about 100 microns, and/or about 15 microns and about 90 microns. In one embodiment, the coal combustion and coal gasification ingredients have a mean particle size between about 15 microns and 30 microns. Since a particle size having a uniform distribution is important, coal byproducts having a particle size larger than 250 microns, or 125 microns, etc. (depending on the application) are crushed and screened to produce a uniform particle size in the appropriate range, which may vary depending upon the friction performance properties being sought.

In another embodiment, each ingredient in the composition has a particle size between about 1 micron and 250 microns, 5 microns and about 125 microns, about 5 microns and about 100 microns, and/or about 15 microns and about 90 microns. Materials having a particle size greater than about 125 microns can be crushed and screened as described above to provide particles in the appropriate range for use in a friction composition, which may vary depending upon the friction performance properties being sought. In a still further embodiment, each raw material ingredient other than the binder and filler components has a mean particle size between about 15 microns and 30 microns.

The invention provides combinations of selected ingredients which have material properties that complement the material properties of each other. The materials may be processed physically or chemically to achieve desired properties in the finished friction material. Frictional materials with different friction performance properties also can be produced by varying the amount and particle size distribution (e.g., mean particle size) of the ingredients listed above.

One advantage of compositions in accordance with the invention is that the abrasive and thermal properties of the various ingredients are different from each other, so their relative proportions may be altered to provide different friction performance results for different applications. Another advantage of the compositions in accordance with the invention is they include fewer discrete ingredients than often used in materials for friction applications. Still another advantage of the compositions in accordance with the invention is that they often include byproducts of coal combustion having high specific heat which in use allow relatively increased heat dissipation away from the friction surface, and thus permit relatively increased heat storage within the friction material. Thus, heat is not typically transferred to the backing plate of a brake pad or other structural component when the friction material used to provide a brake pad. Furthermore, heat is more uniformly distributed throughout the friction material.

The invention further provides methods of making friction materials comprising combining at least two coal combustion and coal gasification byproducts selected from the group consisting of pulverized coal combustion fly ash, pulverized coal combustion bottom ash, FBC fly ash, a vitreous fraction of coal gasification, a wet byproduct of flue gas desulphurization, and fluidized bed combustion dry bottom ash, with at least one binder component, at least one fiber component, and optionally, at least one additional friction modifier component to form a mixture, and molding the mixture to form a friction work piece capable of being used in power transfer and braking applications. The method may further comprise attaching the friction work piece to a steel plate.

In one embodiment, the method comprises selecting ingredients as described above; screening and crushing coal byproducts whose particulate size is larger than 125 microns; mixing the dry ingredients; forming the ingredients into a work piece by introducing the mixture into a die of the desired shape. Advantageously, currently-available hot-press equipment (and conditions) conventionally used in friction product manufacturing such as that used to manufacture disk brake pads can be used to form the mixture into a work piece by compressing the mixture at a high temperature and under pressure for a fixed period of time to form friction work pieces according to the invention. The method may further include screening other raw materials to exclude certain particulate sizes.

Advantageously, the friction materials may be manufactured using current commercial fabrication processes. Typically, molding is effected at elevated temperature and pressure. For example, hot pressing may be used to form the friction work piece.

Work pieces comprising a friction material comprising at least two friction modifier components advantageously obtained from coal combustion and coal gasification byproducts selected from the group consisting of pulverized coal combustion fly ash, pulverized coal combustion bottom ash, fluidized bed combustion fly ash, a vitreous fraction of coal gasification, a wet byproduct of flue gas desulphurization, and fluidized bed combustion dry bottom ash are also provided. Typically, the work piece further comprises a steel plate, and the friction material is attached to the steel plate.

An advantage of work pieces in accordance with the present invention is that the wear on the work piece in use is more homogeneous, and therefore when used in a braking application, the work piece will provide a much larger contact area, thereby providing more efficient braking. For example, greater contact area can be achieved between a brake pad and a rotor to provide more efficient braking in automotive braking applications.

Representative friction materials in accordance with the invention have been molded to form work pieces (e.g., automotive brake pads) and have undergone extensive testing including professionally-recognized testing using Friction Assessment Screening Test (“FAST”) and Dynamometer (SAE J 2430) procedures for automotive brakes. The developed materials have the following significant, advantageous characteristics:
Lower specific gravity (about 1.6 g/ml to about 2.0 g/ml relative to greater than 2.2 g/ml for commercially available materials).
Significantly reduced material cost as compared to current OEM formulations.
Relatively constant coefficient of friction in use.
Coefficient of frictions between about 0.35 and 0.65.
Significantly lower operating temperatures as compared to current commercial brake pads (˜250° C. vs. ˜350° C., respectively), reflecting the greater heat capacity of the friction materials according to the invention.
Improved thermal diffusivity characteristics allowing the material to move more heat away from the friction surface while retaining it within the friction material.
Significantly improved friction-fade characteristics during extended use (i.e., reduced reduction in coefficient of friction observed at higher temperature).
Wear rates similar to commercial brakes (about 6 to about 15% based on dynamometer testing).
Wear over the work piece area that is much more uniform than observed in commercial brakes (based on dynamometer testing).
Improved noise characteristics.
Reduced corrosion observed on brake steel pad and rotor materials.
Reduced number of ingredients.

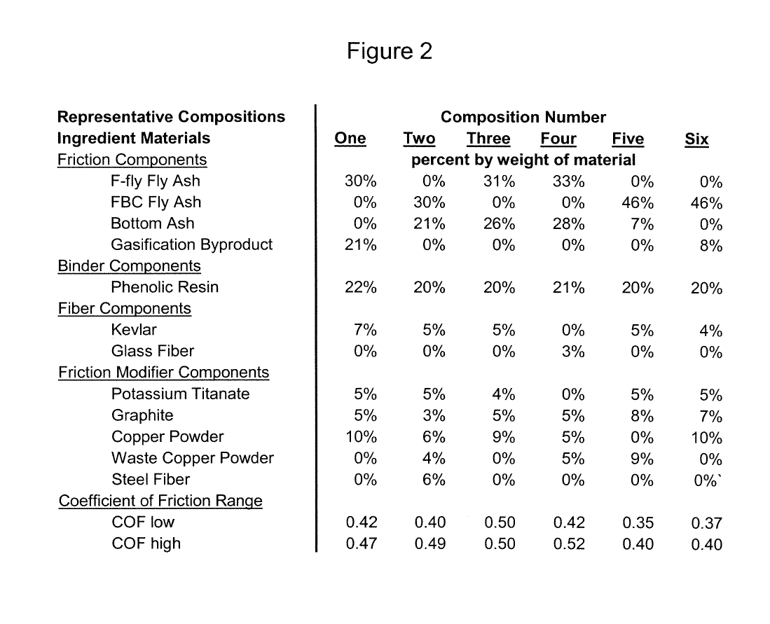

Friction materials and work pieces comprising same in accordance with the invention can be better understood in light of the following examples set forth in FIG. 2. However, the foregoing description and the following examples are merely illustrative, and therefore no unnecessary limitations should be understood there from as numerous modifications and variations are expected to occur to those skilled in the art.

What is claimed is:

1. A friction material composition, comprising:
at least one friction material ingredient selected from the group consisting of F-fly ash, C-Fly ash, and FBC fly ash, copper powder, aluminum powder, and steel powder, the friction material ingredient or combination of friction material ingredients comprising 5% to 55% weight of the composition;
at least one different friction material ingredient selected from the group consisting of bottom ash and coal gasification byproducts, the different friction material ingredient or combination of ingredients comprising 0.1% to 35% weight of the composition;
a reinforcement fiber selected from the group consisting of aramid fibers, copper fibers, steel fibers, glass fibers, and ceramic fibers in an amount from 2% to 12% by weight of the composition;
a binder selected from the group consisting of phenolic resin and epoxy in an amount from 5% to 30% by weight of the composition;
and a lubricating ingredient selected from group consisting of graphite, molybdenum sulfide, and potassium titanate, talc, rubber in an amount of 0.1% to 20% weight of the composition.

2. A friction material composition comprising:
at least two friction modifier components obtained as a byproduct from coal combustion or coal gasification and selected from the group consisting of pulverized coal combustion fly ash, pulverized coal combustion bottom ash, fluidized bed combustion fly ash, a vitreous fraction of coal gasification, a wet byproduct of flue gas desulphurization, and fluidized bed combustion dry bottom ash (“spent-bed material”);
at least one binder component; and
at least one fiber component.

3. The friction material composition according to claim 2, further comprising one or more additional friction modifier components selected from the group consisting of friction developers, fade improvers, and solid lubricants.

4. The friction material composition according to claim 3, wherein the composition further comprises a friction developer selected from the group consisting of aluminum oxide, chromium oxide, silicon oxide, wollastonite, rock wool, mica, vermiculite, magnesium oxide, zinc oxide, and zirconium silicate, steel fibers, potassium titanate, copper powder, aluminum powder, and steel powder

5. The friction material composition according to claim 3, wherein the composition further comprises a fade improver selected from the group consisting of brass chips, brass powder, copper chips, copper powder, aluminum chips, aluminum powder, zinc chips, and zinc powder

6. The friction material composition according to claim 3, wherein the composition further comprises a solid lubricants selected from the group consisting of graphite, metallurgical coke, molybdenum disulfide, talc, and rubber.

7. The friction material composition according to claim 1, wherein the composition comprises from about 5 to about 90 wt. % coal combustion and coal gasification byproduct(s) selected from the group consisting of pulverized coal combustion fly ash, pulverized coal combustion bottom ash, fluidized bed combustion fly ash, a vitreous fraction of coal gasification, a wet byproduct of flue gas desulphurization, and fluidized bed combustion dry bottom ash.

8. The friction material composition according to claim 1, wherein the reinforcement fiber is selected from the group consisting of aramid fibers, copper fibers, steel fibers, glass fibers, and ceramic fibers.

9. The friction material composition according to claim 8, wherein the reinforcement fiber is present in an amount from about 2% to 12% by weight of the composition.

10. The friction material composition according to claim 1, wherein the binder is selected from the group consisting of phenolic resin and epoxy resins.

11. The friction material composition according to claim 10, wherein the binder is present in an amount from 5% to 30% by weight of the composition.

12. The friction material composition according to claim 1, wherein a particle size of the friction modifier components obtained as a byproduct from coal combustion or coal gasification is between about 5 microns and about 125 microns.

13. The friction material composition according to claim 1, wherein a mean particle size of the friction modifier components obtained as a byproduct from coal combustion or coal gasification is between about 15 microns and 30 microns.

14. A method of making a work piece capable of being used in power transfer and braking applications comprising:
combining at least two coal combustion and coal gasification byproducts selected from the group consisting of pulverized coal combustion fly ash, pulverized coal combustion bottom ash, FBC fly ash, a vitreous fraction of coal gasification, a wet byproduct of flue gas desulphurization, and fluidized bed combustion dry bottom ash, with at least one binder component, at least one fiber component, and optionally, at least one additional friction modifier component to form a mixture; and
molding the mixture to form a work piece capable of being used in power transfer and braking applications.

15. The method of claim 14 further comprising attaching the work piece to a steel plate.

16. The method of claim 14, wherein molding is performed at elevated temperature and pressure.

17. A methods of making a work piece capable of being used in power transfer and braking applications comprising:
combining (1) at least one friction material ingredient selected from the group consisting of F-fly ash, C-Fly ash, and FBC fly ash, copper powder, aluminum powder, and steel powder; (2) at least one friction material ingredient selected from the group consisting of bottom ash and coal gasification byproduct; (3) a reinforcement fiber selected from the group consisting of aramid fiber, copper fiber, steel fiber, glass fiber, and ceramic fiber; (4) a binder selected from the group consisting of phenolic resin and epoxy; and (5) a lubricating ingredient selected from group consisting of graphite, molybdenum sulfide, and potassium titanate, talc, and rubber to form a mixture;
mixing the mixture;
molding the mixture to form a work piece capable of being used in power transfer and braking applications.

18. The method of claim 17, further comprising controlling the particle size of the ingredients such that all particles have a particle size in the range of 1 to 250 microns.
forming the mixture by pressing the dry ingredients together in an elevated heat environment under high pressure.

19. A work piece comprising:
a friction material comprising at least two friction modifier components obtained from coal combustion and coal gasification byproducts and selected from the group consisting of pulverized coal combustion fly ash, pulverized coal combustion bottom ash, fluidized bed combustion fly ash, a vitreous fraction of coal gasification, a wet byproduct of flue gas desulphurization, and fluidized bed combustion dry bottom ash;
and a steel plate, wherein the friction material is attached to the steel plate.
